(19) United States
(12) Patent Application Publication
(10) Pub. No.: US 2014/0064879 A1
(43) Pub. Date: Mar. 6, 2014

(54) Ballistic Resistant Fastener

(71) Applicant: Steve McGrade, Beaumont, TX (US)

(72) Inventor: Steve McGrade, Beaumont, TX (US)

(21) Appl. No.: 13/713,660

(22) Filed: Dec. 13, 2012

Related U.S. Application Data
(63) Continuation of application No. 11/974,324, filed on Oct. 12, 2007, now abandoned.
Application No. 11/974,324 is a continuation-in-part of application No. 11/447,000, filed on Jun. 5, 2006, now abandoned.

(51) Int. Cl. F16B 37/00; F41H 1/04

(52) U.S. Cl. CPC F16B 37/00; F41H 1/04
USPC 411/427

(57) ABSTRACT

A ballistic resistant bolt to be used in securing straps on a military combat helmet is provided, the bolt having a bolt head and a shaft extending from the underside surface of the bolt head. The bolt head has a generally circular shape and a side surface. The shaft has a bore extending from the end opposite the bolt head. The ratio of the diameter of the bolt head to the diameter of the shaft is approximately 1.65 to 1. The ratio of the diameter of the bolt head to the height of the side surface is approximately 11 to 1. The proportion of the diameter of the bore measured relative to the diameter of the shaft is between approximately 50% and approximately 73%. Also provided is a means for rotationally engaging the bolt head.

### CROSS REFERENCE TO RELATED APPLICATIONS

The present application is a continuation of U.S. Non-Provisional application Ser. No. 11/974,324 filed Oct. 12, 2007, still pending, which is a continuation-in-part of U.S. Non-Provisional application Ser. No. 11/447,000 filed Jun. 5, 2006, now abandoned, which claims the benefit of prior U.S. Provisional Application No. 60/757,651, filed Jan. 10, 2006.

### FIELD OF THE INVENTION

The present invention relates generally to fasteners, and in specific though non-limiting embodiment, to a ballistic resistant bolt used to secure straps to a ballistic resistant helmet.

### BACKGROUND TO THE INVENTION

Military combat helmets are currently made out of Kevlar® brand material, an aramid fibrous material made from a nylon-like polymer, for example, poly-para-phenylene terephthalamide. Such helmets are designed to be ballistic resistant. A consistent, unsolvable problem has been the design of a ballistic resistant bolt that extends from the outside of the helmet to the inside of the helmet in order to secure the helmet's straps.

Although fastener systems intended to be used in conjunction with ballistic proof and armored panels are known, for example, U.S. Pat. Nos. 5,438,908 and 5,600,084, such systems lack fasteners wherein the bolt itself is ballistic resistant. U.S. Pat. No. 6,854,921, for example, discloses and claims a ballistic cap nut, which is distinguishable from the ballistic resistant bolt disclosed and claimed herein.

### SUMMARY OF THE INVENTION

According to a first set of examples of the invention, a ballistic resistant fastening member is provided. The ballistic resistant fastening member includes a bolt head having a generally circular shape and a shaft. The bolt head further includes a rounded top surface; a side surface disposed about the edge of the rounded surface; and an underside surface disposed opposite the top surface. The shaft extends from the underside surface, and further includes a first end disposed on the underside surface; an opposite end; and a bore extending from the opposite end into the shaft. The ratio of the diameter of the bolt head to the diameter of the shaft is approximately 1.65 to 1. The ratio of the diameter of the bolt head to the height of the side surface is approximately 11 to 1. The ratio of the diameter of the bore to the diameter of the shaft is between approximately 50% and approximately 73%.

In another example, the ballistic resistant fastening member further includes means for rotationally engaging the bolt head. In a further example, the rotational engagement means includes a slot disposed on the top surface of the bolt head. The length of the slot is less than the diameter of the bolt head. In a further example, the width of the slot is less than approximately 0.062 inches. In a further example, the slot has a uniform width of approximately 0.057 inches. In a further example, a portion of the fastening member is disposed between the slot and the bore, whereby communication between the slot and the bore is prevented. In a further example, the depth of the slot is less than approximately 0.029 inches.

In another example, the diameter of the bolt head is between approximately 0.435 inches and approximately 0.440 inches. In another example, the diameter of the bolt head is approximately 0.438 inches.

In another example, the diameter of the shaft is between approximately 0.26 inches and approximately 0.27 inches. In another example, the diameter of the shaft is approximately 0.265 inches.

In another example, the height of the side surface is approximately 0.039 inches.

In another example, the proportion of the diameter of the bore measured relative to the diameter of the shaft is between approximately 55% and approximately 65%.

In another example, the diameter of the bore is sufficient to accommodate approximately 8-32 threads.

In another example, the ratio of the diameter of the bolt head to the length of the shaft is less than approximately 0.98.

According to a second set of examples of the invention, a ballistic resistant bolt for securing straps to a ballistic resistant helmet is provided. The ballistic resistant bolt includes a bolt head having a generally circular shape and a shaft. The bolt head further includes a rounded top surface; a side surface disposed about the edge of the rounded surface; and an underside surface disposed opposite the top surface. The shaft extends from the underside surface, and further includes a first end disposed on the underside surface; an opposite end; and a bore extending from the opposite end into the shaft. The ratio of the diameter of the bolt head to the diameter of the shaft is approximately 1.65 to 1. The ratio of the diameter of the bolt head to the height of the side surface is approximately 11 to 1. The proportion of the diameter of the bore measured relative to the diameter of the shaft is between approximately 50% and approximately 73%.

According to a third set of examples of the invention, a ballistic resistant jacket bolt is provided. The ballistic resistant jacket bolt includes a round bolt head sloping uniformly from an apex to a top circumference edge, the bolt head having a diameter of between 0.435 inches and 0.440 inches and having an straight edge of between 0.039 inches and 0.044 inches; a shaft extending from an underside of the bolt head to an end surface distal from the bolt head with a minimum length of around 0.45 inches, the shaft having a common central axis with the bolt head and a diameter of between around 0.260 inches and 0.270 inches; and an internal threads portion within the shaft extending a distance of around 0.38 inches, the internal threads having approximately 8-32 threads with a thread depth or around 0.375 inches.

In another example, the bolt head contains a slot along a diameter of the bolt head disposed approximately equidistant from an apex of the bolt head, and having a length less than the diameter of the bolt head.

In another example, the slot has a maximum depth of around 0.040 inches.

In another example, the slot has a maximum width of around 0.062 inches.

### BRIEF DESCRIPTION OF THE DRAWINGS

FIG. 1 is a top plan view of a bolt having a single slot disposed within a round bolt head.

FIG. 2 is a side elevation view of the bolt depicted in FIG. 1.

FIG. 3 is a perspective view illustrating the application of ballistic resistant bolts to a helmet.

FIG. 4 is a cut-away side view illustrating the application of a ballistic resistant bolt to a helmet.

### DETAILED DESCRIPTION OF EXAMPLES OF THE INVENTION

The present invention is directed to a ballistic resistant bolt used in a fastener system for securing the straps of a security helmet. In one example embodiment, the fastener is a uniquely designed bolt that extends from the outside of a military combat helmet to the inside of the helmet. The design of the bolt is sufficient to provide a ballistic resistant surface. In one example, the ballistic resistant bolt further includes a bolt head with a slot that allows the bolt to be adjusted in the field.

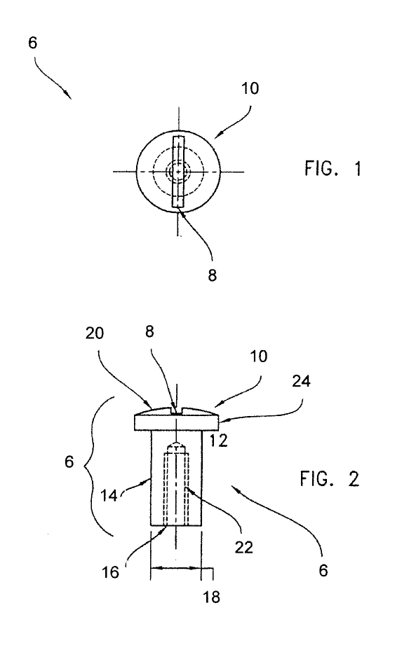

FIG. 1 illustrates a top plan view of a bolt illustrating a single slot contained within a round bolt head. A fastening member, bolt 6, includes a bolt head 10 having a generally circular shape. In an example, a single slot 8 is contained within round bolt head 10. Slot 8 is one example of providing means for rotationally engaging bolt 6. In this depiction, slot 8 extends in a radial direction from the approximate center of bolt head 10, extending toward the outer circumference of bolt head 10.

FIG. 2 illustrates a side elevation view of bolt 6. In this embodiment, bolt head 10 further comprises a rounded top surface 20 having a highest point of relief, or apex, approximately at the center of bolt head 10. Surface 20 of bolt head 10 slopes uniformly downward from the apex towards the circumference edge of bolt head 10. Bolt head 10 is further defined by a side surface 24 extending from the circumference edge to an underside surface 12. In one example, slot 8 is disposed on bolt head 10, extending downward from top surface 20.

Extending from underside surface 12 of bolt head 10 is an elongated shaft 14 that terminates at an end surface 16, end surface 16 being disposed distal from bolt head 10. In this embodiment, shaft 14 has a common central axis with an apex of round bolt head 10. In an alternative example, shaft 14 is cylindrical in shape, having a diameter 18 that is typically less than the diameter of bolt head 10. A bore in the center of shaft 14, along its common central axis, extends from end surface 16 toward bolt head 10, thereby forming an internal barrel 22. At least a portion of the bore in the center of shaft 14 bears internal threads therein.

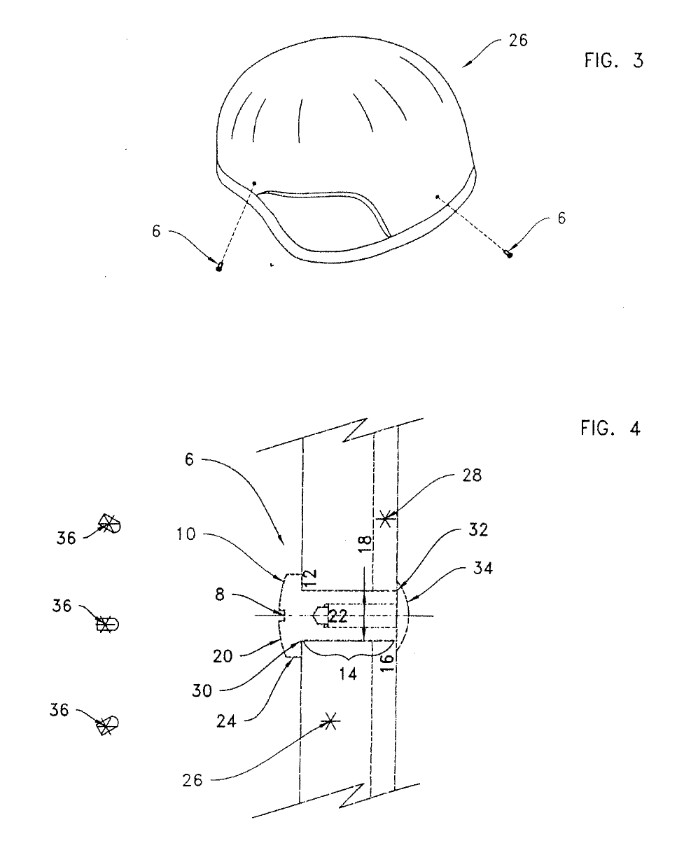

FIG. 3 is a perspective view illustrating the application of a plurality of bolts to a helmet. Bolts 6 are inserted into helmet 26 for use in securing straps to the helmet. For ballistic resistant applications, helmet 26 is made of ballistic resistant materials. In at least one example, helmet 26 includes chinstrap 28 (not shown) to secure helmet 26 in place on the wearer. When so equipped, bolts 6 secure chinstrap 28 to the helmet 26.

FIG. 4 is a cut-away view illustrating the application of a bolt to a helmet. In this embodiment, helmet 26 and chinstrap 28 (shown in cross section for clarity) are secured together. An aperture in helmet 26 and an aperture in chinstrap 28 are of sufficient diameter to allow the bolt 6 to be introduced through both apertures. A fastening element 34 mates with internal threads of internal barrel 22, thereby securing chinstrap 28 to helmet 26.

The helmet user is protected from projectiles 36 approaching bolt head 10 from various angles.

### Bolt Head Diameter.

Referring now collectively to the example embodiments depicted in FIGS. 1-4, the underside surface 12 of bolt head 10 has sufficient surface area so as to prevent bolt 6 from pushing through the apertures of helmet 26 and/or chinstrap 28. However, the diameter of bolt head 10 is limited so as to preserve ballistic resistance. An excessive diameter for bolt head 10, in relation to the diameter of shaft 14, increases the ability of shear forces on bolt head 10 relative to shaft 14 (or shear forces on shaft 14 relative to bolt head 10) to cause failure of bolt 6. In one example, the ratio of the diameter of bolt head 10 to the diameter of shaft 14 is maintained within a tolerance range of approximately 1.65 to 1. Ratios approximate to this ratio provide sufficient bolt head diameter to prevent failure by aperture-entry while concurrently providing sufficient resistance to shear failure between the bolt head and shaft. In a further example, the bolt head diameter is between approximately 0.435 inches and approximately 0.440 inches. In a further example, the bolt head diameter is approximately 0.438 inches. In a further example, the shaft diameter is between approximately 0.26 inches and approximately 0.27 inches. In a further example, the shaft diameter is approximately 0.265 inches.

### Taper Features—Side Surface Features.

Referring to FIGS. 1-2, in one example, bolt head 10 slopes uniformly downward from the apex towards a top circumference edge of bolt head 10, terminating in side surface 24. In one example, side surface 24 extends generally toward end surface 16 in a direction generally longitudinal relative to the axis formed by bolt head 10 and shaft 14, terminating at underside surface 12.

In one example, the distance along side surface 24 from the top circumference edge of bolt head 10 to underside surface 12 is termed the thickness or height of side surface 24. A bolt head, having a top surface that tapers directly into an underside surface, results in presentation of a weak point with ensuing undesirable anti-ballistic properties. A side surface, having at least a certain height or thickness that is thick enough to provide ballistic resistance while concurrently not presenting a bolt head that is too bulky, eliminates the weak point and results in more desirable ballistic resistant properties. In one specific though non-limiting embodiment, the height of side surface 24 is around 0.039 inches for a bolt head 10 having an approximate diameter of 0.435 to 0.440 inches. This represents a bolt-head-diameter to side-surface-height aspect ratio of approximately 11 to 1.

### Slot 8 Features.

Referring to the example embodiments of FIGS. 1-2, the length of slot 8 is less than the diameter of bolt head 10. Strength is provided to bolt 6 by restricting the length of slot 8 to less than the diameter of bolt head 10. The center of slot 8 is located approximately at the apex of the bolt head 10. In one example, the width of slot 8 is approximately no greater than approximately 0.062 inches. In a further example, slot 8 has a uniform width of approximately 0.057 inches. In one example, the width of slot 8 is sufficient to allow rotational engagement by a round token. In a further example, the width of slot 8 is sufficient to allow rotational engagement by the U.S. coin known as a “dime”. In one example, a sufficient portion of bolt head 10 and/or shaft 14 remains disposed between slot 8 and internal barrel 22 so as to prevent communication between slot 8 and internal barrel 22. In one example, slot 8 extends to a maximum depth of 0.029 inches. In at least one example, bolt 6 contains no slot on bolt head 10. In at least one example, the exact dimensions of slot 8 are conformed to a specific application or need.

### Internal Barrel Features.

Referring still to the example embodiments of FIGS. 1-2, the internal barrel 22 is of sufficient diameter so as to provide adequate engagement of a screw or second fastening member to shaft 14 of bolt 6. However, the diameter of internal barrel 22 is limited so as to preserve ballistic resistance of shaft 14. The diameter of internal barrel 22 is limited by the diameter of shaft 14 and the amount of desired wall thickness of shaft 14. An excessive diameter for internal barrel 22, in relation to the diameter of shaft 14, increases the ability of shear forces on bolt head 10 relative to shaft 14 (or shear forces on shaft 14 relative to bolt head 10) to cause failure of bolt 6. In one example, the diameter of the internal barrel to the diameter of the shaft is maintained within a tolerance range of approximately 50% to approximately 73%. Ratios approximate to this ratio provide sufficient adequate engagement of a second fastening member to the shaft while concurrently providing sufficient resistance to shear failure between the bolt head and shaft. For shaft diameters between approximately 0.26 inches and approximately 0.27 inches, this represents a barrel diameter sufficient to accommodate 6-32, 8-32, or 10-32 threads. In a further example, the diameter of the internal barrel to the diameter of the shaft is preferably maintained within a tolerance range of approximately 55% to approximately 65%. For shaft diameters between approximately 0.26 inches and approximately 0.27 inches, this represents a barrel diameter sufficient to accommodate 8-32 threads.

Referring still further to FIGS. 1-2, shaft 14 extends from underside 12 of bolt head 10 to end surface 16 for a distance of 0.5 inches. In one example, the diameter of shaft 14 is 0.265 inches. In another example, internal barrel 22 is threaded with 8-32 threads having a ⅜-inch thread distance. In another example, internal barrel 22 is threaded with 10-24 threads. In a further example, a portion of internal barrel 22 is threaded, providing a grip area without threads. In a further example, a minimum grip length of 0.07 inches is provided. In a further example, depending on a specific application or need, the exact dimensions of the shaft 14 and threading of internal barrel 22 is altered.

### Shaft Length to Bolt Head Ratio.

In one example, the ratio of the diameter of bolt head 10 to the length of shaft 14 is less than approximately 0.98.

### Choice of Materials.

In one example, bolt 6 is constructed of stainless steel. In a further example, other suitable, ballistic resistant materials are used. In another example, bolt 6 is coated with a black oxide finish for corrosion resistance.

### Operation.

In a further embodiment, helmet 26 and chinstrap 28 are positioned during assembly such that the apertures are approximately aligned. In a presently preferred embodiment, a single bolt 6 extends through both apertures. Typically, bolt 6 would be secured in position using fastening element 34. In one example, bolt 6 is adjusted in the field, using slot 8. This is accomplished by inserting a common flat-headed implement into slot 8 and rotating. In this particular example, slot 8 is sized for minimum impairment of the ballistic resistant properties of bolt 6 while being concurrently sized for a readily available common flat-headed implement. In a particular example, the common flat-headed implement is a round metal token of size and shape to correspond to a U.S. dime or another roughly disk-shaped object having a predetermined thickness. In this example, the size and shape of slot 8 provides the user with a field-adjustable helmet while avoiding the need for the user to carry a specialized tool in order to adjust bolt 6, thereby reducing weight requirements in the field.

The present invention thus provides a unique fastener assembly for use in applications that require ballistic resistant. While it is especially well adapted for use with helmets, it will be appreciated that the fastener assembly of the present invention is readily adapted for use with little or no modification in virtually any form of mobile platform where security and ballistic resistant properties are important considerations. The fastener assembly of the present invention is not limited to use with only mobile platforms, but may also be implemented in virtually any stationary structure where ballistic resistant is a concern.

### Other Options

In addition to the example dimensions and specifications described above, the present ballistic resistant fastener is also capable of serving as a housing for a variety of tracking devices. For example, a hollowed out portion of the fastener shaft, or alternatively, an extended portion of the shaft or even another portion of the fastener, can be equipped with a receiver and/or transmitter and disposed in communication with a global positioning system or another monitoring system, so that security forces wearing helmets equipped with the claimed fasteners can be tracked while on a mission, or located should they become lost or injured. Infrared and radio frequency applications can vary according to transmission and receiving distances, as can any other small, portable tracking or communication device, so long as the electronics package is sufficiently miniaturized as to admit to housing within the devices described herein.

In addition to tracking applications, an internal void space or extension of the fastener shaft is also practical for electronic packages used to facilitate communications between an individual wearing a helmet equipped with the fastener and another similarly equipped individual, or between the wearer and a home base or central communication point, so that movement between various individuals equipped with the device can be remotely monitored and controlled. In other embodiments, the package serves as a scrambler or blocker of other signals that might otherwise be used by a hostile force to locate or track the wearer.

In still other embodiments, the claimed fastener houses an illumination means so that the wearer can be equipped with an infrared light or light of another spectrum to assist the visual aspects of a search or patrol mission, for example.

In short, any type of electronics package can be inserted into a void space formed in the fastener, or within or upon an extension of the fastener shaft (or even an annular, washer-like device disposed beneath the head of the fastener), the only functional limitation being that the package housing must conform generally to the existing shape and contours of the ballistic resistant fastener claimed herein.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will appreciate that minor changes to the description, and various other modifications, omissions and additions may also be made without departing from either the spirit or scope thereof.

1. A ballistic resistant fastening member comprising:
a bolt head having a generally circular shape, said bolt head further comprising
a rounded top surface;
a side surface disposed about the edge of said rounded surface; and
an underside surface disposed opposite said top surface;
a shaft extending from said underside surface, said shaft further comprising
a first end disposed on said underside surface;
an opposite end; and
a bore extending from said opposite end into said shaft;
wherein the ratio of the diameter of said bolt head to the diameter of said shaft is about 1.65 to 1;
wherein the ratio of the diameter of said bolt head to the height of said side surface is about 11 to 1; and
wherein the ratio of the diameter of said bore to the diameter of said shaft is between about 50% and about 73%.

2. The ballistic resistant fastening member of claim 1 further comprising means for rotationally engaging said bolt head.

3. The ballistic resistant fastening member of claim 2 wherein said rotational engagement means comprises a slot disposed on said top surface of said bolt head and wherein the length of said slot is less than the diameter of said bolt head.

4. The ballistic resistant fastening member of claim 3 wherein the width of said slot is less than about 0.062 inches.

5. The ballistic resistant fastening member of claim 3 wherein said slot has a uniform width of about 0.057 inches.

6. The ballistic resistant fastening member of claim 3 wherein a portion of said fastening member is disposed between said slot and said bore, whereby communication between said slot and said bore is prevented.

7. The ballistic resistant fastening member of claim 3 wherein the depth of said slot is less than about 0.029 inches.

8. The ballistic resistant fastening member of claim 1 wherein the diameter of said bolt head is between about 0.435 inches and about 0.440 inches.

9. The ballistic resistant fastening member of claim 1 wherein the diameter of said bolt head is about 0.438 inches.

10. The ballistic resistant fastening member of claim 1 wherein the diameter of said shaft is between about 0.26 inches and about 0.27 inches.

11. The ballistic resistant fastening member of claim 1 wherein the diameter of said shaft is about 0.265 inches.

12. The ballistic resistant fastening member of claim 1 wherein the height of said side surface is about 0.039 inches.

13. The ballistic resistant fastening member of claim 1 wherein the ratio of the diameter of said bore to the diameter of said shaft is between about 55% and about 65%.

14. The ballistic resistant fastening member of claim 1 wherein the diameter of said bore is sufficient to accommodate 8-32 threads.

15. The ballistic resistant fastening member of claim 1 wherein the ratio of the diameter of said bolt head to the length of said shaft is less than about 0.98.

16. A ballistic resistant bolt for securing straps to a ballistic resistant helmet, said bolt comprising:
a bolt head having a generally circular shape, said bolt head further comprising
a rounded top surface;
a side surface disposed about the edge of said rounded surface; and
an underside surface disposed opposite said top surface;
a shaft extending from said underside surface, said shaft further comprising
a first end disposed on said underside surface;
an opposite end; and
a bore extending from said opposite end into said shaft;
wherein the ratio of the diameter of said bolt head to the diameter of said shaft is approximately 1.65 to 1;
wherein the ratio of the diameter of said bolt head to the height of said side surface is approximately 11 to 1; and
wherein the ratio of the diameter of said bore to the diameter of said shaft is between approximately 50% and approximately 73%.

17. A ballistic resistant jacket bolt comprising:
a round bolt head sloping uniformly from an apex to a top circumference edge, said bolt head having a diameter of between 0.435 inches and 0.440 inches and having a straight edge of between 0.039 inches and 0.044 inches;
a shaft extending from an underside of said bolt head to an end surface distal from said bolt head with a minimum length of 0.45 inches, said shaft having a common central axis with said bolt head and a diameter of between 0.260 inches and 0.270 inches; and
an internal threads portion within said shaft extending a distance of 0.38 inches, said internal threads having 8-32 threads with a 0.375 inch thread depth.

18. The ballistic resistant jacket bolt of claim 17, wherein said bolt head contains a slot along a diameter of said bolt head equidistant from an apex of said bolt head and having a length less than a said diameter of said bolt head.

19. The ballistic resistant jacket bolt of claim 18, wherein said slot has a maximum depth of about 0.040 inches.

20. The ballistic resistant jacket bolt of claim 18, wherein said slot has a maximum width of about 0.062 inches.
